(19) United States
(12) Patent Application Publication
(10) Pub. No.: US 2023/0192566 A1
(43) Pub. Date: Jun. 22, 2023

(54) Alkali-silicate-based initiator component for use in a cementitious inorganic multi-component mortar system

(71) Applicant: Hilti Aktiengesellschaft, Schaan (LI)

(72) Inventors: Markus SCHÖNLEIN, Gilching (DE); Armin Pfeil, Landsberg am Lech (DE); Bernhard Middendorf, Calden (DE); Tim Schade, Kassel (DE)

(21) Appl. No.: 17/998,665

(22) PCT Filed: May 6, 2021
(86) PCT No.: PCT/EP2021/062010

§ 371 Date: Nov. 13, 2022

(30) Foreign Application Priority Data
May 15, 2020 (EP) 20174879.5

(51) Int. Cl. C04B 40/06; C04B 28/00; C04B 7/28; C04B 28/26

(52) U.S. Cl. CPC C04B 40/065; C04B 28/006; C04B 7/28; C04B 28/26; C04B 2111/00112

(57) ABSTRACT

A cementitious multi-component mortar system contains granulated blast-furnace slag and an alkali-silicate-based initiator component, and can be used for the chemical fastening of anchoring elements in mineral substrates. The alkali-silicate-based initiator component is particularly suitable for the chemical fastening of galvanized anchoring elements.

### FIELD OF THE INVENTION

The invention is in the field of the chemical fastening of anchoring elements, in particular galvanized anchoring elements, in mineral substrates in the field of construction and fastening technology, and in particular relates to the chemical fastening of anchoring elements by means of an alkali-silicate-activatable cementitious inorganic multi-component mortar system comprising granulated blast-furnace slag.

### PRIOR ART

Composite mortars for fastening anchoring elements in mineral substrates in the field of construction and fastening technology are known. These composite mortars are based almost exclusively on organic epoxy-containing resin/hardener systems. However, it is well known that such systems are polluting, expensive, potentially hazardous and/or toxic to the environment and the person handling them and they often need to be specially labeled. In addition, organic systems often exhibit greatly reduced stability when exposed to strong sunlight or otherwise elevated temperatures, which reduces their mechanical performance in the chemical fastening of anchoring elements. In addition, problems can occur with the chemical fastening of galvanized anchoring elements due to zinc corrosion or contact corrosion caused by the chemical fastening means. In the long term, these anchoring elements cannot have sufficiently high loads due to the chemical fastening.

There is therefore a need for a ready-to-use cementitious multi-component mortar system, preferably a cementitious two-component mortar system, which is superior to the prior art systems in terms of environmental aspects, health and safety, handling, storage time and a good balance between setting and curing. In particular, it is of interest to provide a system that can be activated in such a gentle way and which, when used, does not damage the surface of galvanized anchoring elements.

Furthermore, it is of interest to provide an initiator component for a cementitious inorganic multi-component mortar system comprising granulated blast-furnace slag, whereby the mortar system can be used for the chemical fastening of in particular galvanized anchoring elements in mineral substrates without adversely affecting the handling, properties and mechanical performance of the chemical fastening system.

In view of the above, it is also an object of the present invention to provide a cementitious system, in particular a cementitious multi-component mortar system, in particular a cementitious two-component mortar system, which overcomes the disadvantages of the prior art systems. In particular, it is an object to provide a ready-to-use cementitious multi-component mortar system which is easy to handle and environmentally friendly, which can be stored stably for a certain period of time prior to use and which has a good balance between setting and curing, and also exhibits excellent mechanical performance under the influence of elevated temperatures in the chemical fastening of in particular galvanized anchoring elements in mineral substrates.

Furthermore, it is an object of the present invention to provide a cementitious multi-component mortar system which can be used for the chemical fastening of anchoring means, preferably galvanized metal elements, in mineral substrates, such as structures made of brick, natural stone, concrete, permeable concrete or the like.

This and further objects, which will become apparent from the following description of the invention, are solved by the present invention, as described in the independent claims. The dependent claims relate to preferred embodiments.

### SUMMARY OF THE INVENTION

The present invention relates to a cementitious multi-component mortar system comprising granulated blast-furnace slag and an alkali-silicate-based initiator component, which is ideally suited for use as an inorganic chemical fastening system for anchoring elements in mineral substrates in order to achieve high load values. In particular, the present invention relates to a cementitious multi-component mortar system comprising granulated blast-furnace slag and an alkali-silicate-based initiator component for the chemical fastening of galvanized anchoring elements in mineral substrates, the alkali-silicate-based initiator component having a pH in a range of from 12.5 to 13.5.

The present invention further relates to an alkali-silicate-based initiator component for a cementitious inorganic multi-component mortar system comprising granulated blast-furnace slag, for the chemical fastening of anchoring elements, in particular galvanized anchoring elements, in mineral substrates.

The present invention also relates to the use of such a cementitious multi-component mortar system and such an alkali-silicate-based initiator component for the chemical fastening of anchoring means, preferably metal elements, in mineral substrates, such as structures made of brick, natural stone, concrete, permeable concrete or the like.

Some other objects and features of this invention are obvious and some will be explained hereinafter. In particular, the subject matter of the present invention will be described in detail on the basis of the embodiments.

### DETAILED DESCRIPTION OF THE INVENTION

The following terms are used within the scope of the present invention:

In the context of the present invention, the term “binder” or “binder component” relates to the cementitious component, and optional components such as fillers, of the multi-component mortar system. In particular, this is also referred to as the A component.

In the context of the present invention, the term “initiator” or“initiator component” relates to the aqueous alkali-silicate-based component which triggers stiffening, solidification and hardening as a subsequent reaction. In particular, this is also referred to as the B component.

The terms “comprise,” “with” and “have” are intended to be inclusive and mean that elements other than those cited may also be meant.

As used within the scope of the present invention, the singular forms “a” and “an” also include the corresponding plural forms, unless something different can be inferred unambiguously from the context. Thus, for example, the term “a” is intended to mean “one or more” or “at least one,” unless otherwise indicated.

Various types of cement, their composition and their areas of application are known from the prior art, but their use as an inorganic chemical fastening system, in particular, the use of a cementitious multi-component mortar system based on granulated blast-furnace slag, is still largely unknown.

It has now been found that a cementitious multi-component mortar system comprising granulated blast-furnace slag and an alkali-silicate-based initiator component is ideally suited for the chemical fastening of galvanized anchoring elements in mineral substrates, the alkali-silicate-based initiator component having a pH in a range of from 12.5 to 13.5.

It has also been found that an alkali-silicate-based initiator component is particularly suitable for a cementitious inorganic multi-component mortar system comprising granulated blast-furnace slag, for the chemical fastening of anchoring elements in mineral substrates, in particular galvanized anchoring elements.

Furthermore, the systems, in particular the cementitious multi-component mortar system, are characterized by positive advantages in terms of environmental aspects, health and safety, handling, storage time and a good balance between setting and curing, without adversely affecting the handling, properties and mechanical performance of the chemical fastening system.

The present invention therefore relates to a cementitious multi-component mortar system comprising granulated blast-furnace slag and an alkali-silicate-based initiator component for the chemical fastening of galvanized anchoring elements in mineral substrates, the alkali-silicate-based initiator component having a pH in a range of from 12.5 to 13.5.

It is preferred that the granulated blast-furnace slag be present in the binder component. It is particularly preferred that the cementitious multi-component mortar system is a two-component mortar system and comprises a powdered cementitious binder component and an aqueous alkali-silicate-based initiator component.

The granulated blast-furnace slag, the main component of so-called Portland slag and blast-furnace cements, of the cementitious multi-component mortar system comprises from 30 to 45% calcium oxide (CaO), from 30 to 45% silicon dioxide (SiO₂), from 1 to 15% aluminum oxide (Al₂O₃) and from 4 to 17% iron oxide (MgO), and 0.5 to 1% sulfur (S). Other characteristics of the granulated blast-furnace slag are iron oxide (Fe₂O₃), sodium oxide (Na₂O), potassium oxide (K₂O), chloride, sulfur trioxide (SO₃) and manganese oxide (Mn₂O₃), which preferably make up less than 5% of the granulated blast-furnace slag.

The multi-component cementitious mortar system of the present invention can also comprise ground granulated blast-furnace slag with a grinding fineness in the range of from 4000 to 12000 cm²/g.

The cementitious multi-component mortar system of the present invention preferably comprises granulated blast-furnace slag in a range of from 1 wt. % to 60 wt. %, more preferably from 10 wt. % to 50 wt. %, most preferably in a range of from 25 wt. % to 45 wt. %, based on the total weight of the binder component.

Preferably, the multi-component cementitious mortar system further comprises silica fume. The silica fume is preferably present in the binder component.

The silica fume of the cementitious multi-component mortar system is present in a range of from 1 wt. % to 10 wt. %, preferably from 2 wt. % to 8 wt. %, most preferably in a range of from 4 wt. % to 7.5 wt. %, based on the total weight of the binder component. The silica fume preferably has an average particle size of 0.4 μm and a surface area of from 180,000 to 220,000 cm²/g or 18-22 m²/g.

Alternatively, the silica fume can also be replaced by pozzolanic materials or by materials with pozzolanic properties or by other fine inert fillers. These are, for example, fly ash, limestone powder, corundum, calcite, dolomite, brick dust, rice husk ash, phonolite, calcined clay and metakaolin.

In a preferred embodiment of the cementitious multi-component mortar system, the silica fume is present in a range of from 5 wt. % to 8 wt. %, based on the total weight of the binder component.

Furthermore, at least one filler or filler mixtures can be present in the binder component. These are preferably selected from the group consisting of quartz, sand, quartz powder, clay, fly ash, granulated blast-furnace slag, pigments, titanium oxides, light fillers, limestone fillers, corundum, dolomite, alkali-resistant glass, crushed stones, gravel, pebbles and mixtures thereof.

The at least one filler of the cementitious multi-component mortar system is preferably present in a range of from 20 wt. % to 80 wt. %, more preferably from 30 wt. % to 70 wt. %, most preferably in a range from 40 wt. % to 60 wt. %, based on the total weight of the binder component.

In a preferred embodiment of the cementitious multi-component mortar system, the filler is sand and is present in a range of from 45 to 55 wt. %, based on the total weight of the binder component.

In a particularly preferred embodiment of the present invention, the filler is a mixture of sand and quartz powder. The sand is preferably present in a range of from 45 wt. % to 55 wt. % and the quartz powder in a range of from 5 wt. % to 10 wt. %, based on the total weight of the binder component.

Furthermore, the binder component can contain other cements, such as calcium-aluminate-based cement. Furthermore, the binder component can contain fibers such as mineral fibers, chemical fibers, natural fibers, synthetic fibers, fibers made of natural or synthetic polymers, or fibers made of inorganic materials, in particular carbon fibers or glass fibers.

The alkali-silicate-based initiator component of the multi-component mortar system preferably comprises an alkali-metal-silicate-based component, the alkali metal silicate being selected from the group consisting of sodium silicate, potassium silicate, lithium silicate, modifications thereof, mixtures thereof and aqueous solutions thereof. In a preferred embodiment, the alkali-silicate-based initiator component is an aqueous solution of potassium silicate and potassium hydroxide. In a particularly preferred embodiment, the initiator component is an aqueous solution of 10 mol/l KOH and 1.72 mol/l potassium silicate (Betol® K 35 T, Woellner, Germany).

In a preferred embodiment of the present invention, the alkali-metal-silicate-based initiator component comprises 1 to 50 wt. % silicate, preferably 10 to 40 wt. %, particularly preferably 15 to 30 wt. %, based on the total weight of the aqueous alkali metal silicate.

The alkali-silicate-based initiator component comprises at least approximately 0.01 wt. %, preferably at least 0.02 wt. %, particularly preferably at least approximately 0.05 wt. %, particularly preferably at least 1 wt. %, from approximately 0.01 wt. % to approximately 40 wt. %, preferably from approximately 0.02 wt. % to approximately 35 wt. %, more preferably from approximately 0.05 wt. % to approximately 30 wt. %, particularly preferably from approximately 1 wt. % to approximately 25 wt. % of the alkali-silicate-based component, based on the total weight of initiator component.

It has now been found that the alkali-silicate-based initiator component used according to the invention is outstandingly suitable for the chemical fastening of anchoring elements, in particular galvanized anchoring elements, in mineral substrates when it is used in a cementitious inorganic multi-component mortar system comprising granulated blast-furnace slag and has a pH in a range of from 12.5-13.5.

In particular, an alkali-silicate-based initiator component with a pH in a range of from 12.5-13 is used in a multi-component cementitious mortar system comprising granulated blast-furnace slag in order to achieve suitable load values of galvanized anchor rods compared to conventional anchor rods. The alkali-silicate-based initiator component with a pH in a range of from 12.5-13 prevents surface damage and can therefore be used for fastening galvanized anchor rods.

The alkali-silicate-based initiator component of the multi-component mortar system optionally comprises a plasticizer. The optional plasticizer is present in a range of from 1 wt. % to 30 wt. %, preferably from 5 wt. % to 25 wt. %, most preferably in a range from 10 wt. % to 20 wt. %, based on the total weight of the initiator component. The optional plasticizer is selected from the group consisting of polyacrylic acid polymers with low molecular weight (LMW), superplasticizers from the family of polyphosphonate polyox and polycarbonate polyox, polycondensates, for example naphthalene sulfonic acid formaldehyde polycondensate or melamine sulfonic acid formaldehyde polycondensate, lignosulfonates and ethacrylic superplasticizers from the polycarboxylate ether group, and mixtures thereof, for example Ethacryl® G (Coatex, Arkema Group, France), Acumer® 1051 (Rohm and Haas, UK) or Sika® VisoCrete®-20 HE (Sika, Germany). Suitable plasticizers are commercially available products.

In a very special embodiment of the cementitious multi-component mortar system, the water content is 90 wt. % to 95 wt. % and the plasticizer content is 5 wt. % to 10 wt. %, based on the total weight of the initiator component.

Furthermore, at least one filler or filler mixtures can be present in the initiator component. These are preferably selected from the group consisting of quartz, sand, quartz powder, clay, fly ash, pigments, titanium oxides, light fillers, limestone fillers, corundum, dolomite, alkali-resistant glass, crushed stones, gravel, pebbles and mixtures thereof.

The alkali-silicate-based initiator component can additionally comprise a thickener. The thickener can be selected from the group consisting of bentonite, silica, acrylate-based thickeners, such as alkali-soluble or alkali-swellable emulsions, quartz dust, clay and titanate chelating agents, Examples given are polyvinyl alcohol (PVA), hydrophobically modified alkali-soluble emulsions (HASE), hydrophobically modified ethylene oxide urethane polymers, which are known in the art as HEUR, and cellulose thickeners such as hydroxymethyl cellulose (HMC), hydroxyethyl cellulose (HEC), hydrophobically modified hydroxyethyl cellulose (HMHEC), sodium carboxymethyl cellulose (SCMC), sodium carboxymethyl-2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, 2-hydroxypropyl cellulose, attapulgite clay, and mixtures thereof. Suitable thickeners are commercially available products such as Optigel WX (BYK-Chemie GmbH, Germany), Rhealate 1 (Elementis GmbH, Germany) and Acrysol ASE-60 (The Dow Chemical Company).

The presence of the above-mentioned components does not change the overall inorganic nature of the cementitious multi-component mortar system.

The A component or binder component, which comprises the granulated blast-furnace slag, is in solid form, preferably in the form of a powder or dust. The B component or initiator component is in aqueous form, possibly in the form of a slurry or paste.

The weight ratio between the A component and the B component (NB) is preferably between 10/1 and 1/3, and is preferably 8/1-4/1. The cementitious multi-component mortar system preferably comprises the A component in an amount of up to 80 wt. % and the B component in an amount of up to 40 wt. %.

After being prepared separately, the A component and the B component are placed in separate containers from which they can be mixed by mechanical action. In particular, the cementitious multi-component mortar system is a two-component mortar system, preferably a cementitious two-component capsule system. The system preferably comprises two or more film pouches for separating the curable binder component and the initiator component. The contents of the chambers, glass capsules or pouches, such as film pouches, which are mixed with one another under mechanical action, preferably by introducing an anchoring element, are preferably already present in a borehole. The arrangement in multi-chamber cartridges or tubs or sets of buckets is also possible.

The cementitious multi-component mortar system of the present invention can be used for the chemical fastening of anchoring elements, preferably galvanized metal elements, such as anchor rods, in particular threaded rods, bolts, steel reinforcing rods or the like, in mineral surfaces such as structures made of brick, concrete, permeable concrete or natural stone. In particular, the cementitious multi-component mortar system of the present invention can be used for the chemical fastening of galvanized anchoring elements, such as metal elements, in boreholes.

In addition, the cementitious multi-component mortar system of the present invention can be used for the application of fibers, scrims, knitted fabrics or composites, in particular fibers with a high modulus, preferably carbon fibers, in particular for reinforcing building structures, for example walls or ceilings or floors, and also for mounting components, such as panels or blocks, e.g. made of stone, glass or plastic, on buildings or structural elements.

The following examples illustrate the invention without thereby limiting it.

### Examples

### 1. Composition of the Granulated Blast-Furnace Slag

TABLE 1
Chemical composition of the granulated blast-furnace slag
powder, determined using X-ray fluorescence analysis (XRF).

| | Granulated | | |
|---|---|---|---|
| | blast-furnace | | |
| | slag name | H4000 | H12000 |
| Oxides | SiO₂ | 38.1 | 38.51 |
| [m. %] (XRF) | Al₂O₃ | 9.89 | 10.02 |
| | Fe₂O₃ | 0.41 | 0.41 |
| | CaO | 40.33 | 39.68 |
| | MgO | 5.68 | 5.79 |
| | SO₃ | 2.74 | 2.74 |
| | S | 1.12 | 1.10 |
| | Na₂O | 0.41 | 0.42 |
| | K₂O | 0.74 | 0.75 |
| | Mn₂O₃ | 0.58 | 0.57 |
| | Cl | 0.01 | 0.01 |
| Grinding | | 4,000 | 12,000 |
| fineness of the | | | |
| granulated | | | |
| blast-furnace | | | |
| slag in cm²/g | | | |
| (Blaine) | | | |
| Size | | 0.1-100 | 0.1-10 |
| distribution | | | |
| (μm) | | | |

### 2. Preparation of A Component and B Component

The powdered binder components (A component) and the liquid initiator components (B component) in comparative examples 1-4 and 7-10 and examples 5-6 and 11-13 and according to the invention are prepared initially by mixing the components specified in tables 2 and 3 in the proportions specified in table 4, which are expressed in wt. %.

TABLE 2
Composition of the A component based on
granulated blast-furnace slag (wt. %)

| | | | Binder | | Filler |
|---|---|---|---|---|---|
| | Binder | Binder | Silica | Filler | Quartz |
| | H4000 | H12000 | fume¹⁾ | Sand²⁾ | powder³⁾ |
| A0 | 34.5 | | 7.5 | 50 | 8 |
| A1 | | 34.5 | 7.5 | 50 | 8 |

¹⁾Silica fume: Grinding fineness in cm²/g (Blaine) 18,000-22,000; size distribution (μm) 0.1-1.
²⁾Sand: Size distribution (μm) 125-1000.
³⁾Quartz powder: Size distribution (μm) 0.1-100.

TABLE 3
Composition of the B component (wt. %).

| | Initiator | Initiator | pH of the alkali |
|---|---|---|---|
| | KOH | K₂SiO₃ | silicate |
| | 10 mol/l | 1.72 mol/l | solution |
| B0 | 50 | 50 | Above 13.5 |
| B1 | 40 | 60 | Above 13.5 |
| B2 | 33 | 67 | Above 13.5 |
| B3 | 30 | 70 | 13.5 |
| B4 | 25 | 75 | 13 |
| B5 | 20 | 80 | 12.5 |

TABLE 4
Mixing ratio of A component to B component.

| A component | B component | B/A ratio | Water/binder ratio |
|---|---|---|---|
| A0 | B0 | 0.198 | 0.3 |
| A0 | B1 | 0.198 | 0.3 |
| A0 | B2 | 0.198 | 0.3 |
| A0 | B3 | 0.198 | 0.3 |
| A0 | B4 | 0.198 | 0.3 |
| A0 | B5 | 0.198 | 0.3 |
| A1 | B0 | 0.150 | 0.225 |
| A1 | B1 | 0.150 | 0.225 |
| A1 | B2 | 0.150 | 0.225 |

### 3. Determination of Mechanical Performance

After being prepared separately, the powdered binder component A and the initiator component B are mixed using a mixer. All samples are mixed for 1 minute. The mixtures are poured into a stainless-steel sleeve borehole having a diameter of 12 mm, an anchorage depth of 32 mm and ground undercuts of 0.33 mm. Immediately after filling, an MB threaded rod with a length of 100 mm is inserted into the borehole.

The load values of the cured mortar compositions are determined at specific times within 24 hours using a “Zwick Roell Z050” material testing device (Zwick GmbH & Co. KG, Ulm, Germany). The stainless-steel sleeve is fastened to a panel, while the threaded rod is fastened to the force measuring device with a nut. With a preload of 500 N and a test speed of 3 mm/min, the fracture load is determined by pulling out the threaded rod centrally. Each sample consists of an average of five extracts. The fracture load is calculated as the internal strength and given in table 5 in N/mm².

TABLE 5
Internal strength in N/mm².

| | | | Stainless- | | | |
|---|---|---|---|---|---|---|
| | | | steel | Galvanized | | Internal |
| | | | threaded | threaded | Setting time | strength |
| | Example | Components | rod | rod | in min | in N/mm² |
| Comparative | 1 | A0 + B0 | X | | 26 | 23.5 |
| examples | 2 | A0 + B0 | | X | 26 | 1.7 |
| | 3 | A0 + B1 | | X | — | — |
| | 4 | A0 + B2 | | X | 19 | 6.9 |
| | 5 | A0 + B3 | | X | 15 | 10.8 |
| | 6 | A0 + B4 | | X | 10 | 17.2 |
| Comparative | 7 | A1 + B0 | X | | 10 | 29.9 |
| examples | 8 | A1 + B0 | | X | 10 | 7.6 |
| | 9 | A1 + B1 | | X | 7 | 13.7 |
| | 10 | A1 + B2 | | X | 4.5 | 15.0 |
| | 11 | A1 + B3 | | X | 3 | 25.7 |
| | 12 | A1 + B4 | | X | 2.5 | 24.8 |
| | 13 | A1 + B5 | | X | 2 | 21.5 |

As can be seen from table 5, after curing for 24 hours all measurable systems according to the invention show considerable internal strengths and increased load values and thus improved mechanical strengths compared to the comparison systems, whereby the alkali-silicate-based B component has a pH of above 13.5, and is outstandingly suitable for the chemical fastening of galvanized anchoring elements.

1: A cementitious multi-component mortar system for chemical fastening of galvanized anchoring elements in mineral substrates, comprising:
granulated blast-furnace slag, and
an alkali-silicate-based initiator component,
wherein the alkali-silicate-based initiator component has a pH in a range of from 12.5 to 13.5.

2: The cementitious multi-component mortar system according to claim 1, further comprising silica fume.

3: The cementitious multi-component mortar system according to claim 1, further comprising at least one mineral filler selected from the group consisting of quartz, sand, quartz powder, clay, fly ash, granulated blast-furnace slag, a pigment, a titanium oxide, a light filler, a limestone filler, corundum, dolomite, alkali-resistant glass, crushed stone, gravel, pebbles, and a mixture thereof.

4: The cementitious multi-component mortar system according to claim 1, wherein the cementitious multi-component mortar system is a two-component mortar system.

5: The cementitious multi-component mortar system according to claim 4, wherein the two-component mortar system comprises:
a powdered A component, comprising the granulated blast-furnace slag and silica fume, and
an aqueous B component.

6: The cementitious multi-component mortar system according to claim 1, therein the alkali-silicate-based initiator component comprises an alkali-metal-silicate-based component, comprising an alkali metal silicate selected from the group consisting of sodium silicate, potassium silicate, lithium silicate, a modification thereof, a mixture thereof, and an aqueous solution thereof.

7: The cementitious multi-component mortar system according to claim 1, wherein the alkali-silicate-based initiator component is an aqueous solution of potassium hydroxide and potassium silicate.

8: The cementitious multi-component mortar system according to claim 1, wherein the granulated blast-furnace slag is present in a range of from 1 wt. % to 50 wt. %, based on a total weight of a binder component of the cementitious multi-component mortar system.

9: The cementitious multi-component mortar system according to claim 2, wherein the silica fume is present in a range of from 1 wt. % to 10 wt. %, based on a total weight of a binder component of the cementitious multi-component mortar system.

10: An alkali-silicate-based initiator component, for a cementitious inorganic multi-component mortar system comprising granulated blast-furnace slag, for chemical fastening of anchoring elements in mineral substrates.

11: The alkali-silicate-based initiator component according to claim 10, wherein the alkali-silicate-based initiator component has a pH in a range of from 12.5 to 13.5.

12: The alkali-silicate-based initiator component according to claim 10, wherein the alkali-silicate-based initiator component comprises an alkali-metal-silicate-based component, comprising an alkali metal silicate selected from the group consisting of sodium silicate, potassium silicate, lithium silicate, a modification thereof, a mixture thereof, and an aqueous solution thereof.

13: A method of preparing an inorganic chemical fastening system for galvanized anchoring elements in mineral substrates for increasing load values, the method comprising:
mixing the alkali-silicate-based initiator component according to claim 10 into a cementitious multi-component mortar system comprising granulated blast-furnace slag.

14: The method according to claim 13, wherein the cementitious multi-component mortar system further comprises silica fume.

15: A method of chemical fastening of a galvanized anchoring element in a mineral substrate, the method comprising:
initiating curing of the cementitious multi-component mortar system according to claim 1, with the alkali-silicate-based initiator component.

16: The cementitious multi-component mortar system according to claim 4, wherein the two-component mortar system is a two-component capsule mortar system.

17: The cementitious multi-component mortar system according to claim 5, wherein the granulated blast-furnace slag has a grinding fineness in a range of from 4,000 to 12,000 cm²/g.

18: The alkali-silicate-based initiator component according to claim 10, wherein the anchoring elements are galvanized anchoring elements.
